(19) United States
(12) Patent Application Publication
(10) Pub. No.: US 2025/0209660 A1
(43) Pub. Date: Jun. 26, 2025

(54) SYSTEM, METHOD, AND NON-TRANSITORY COMPUTER-READABLE MEDIUM

(71) Applicant: TOYOTA JIDOSHA KABUSHIKI KAISHA, Aichi-ken (JP)

(72) Inventors: Rishi Alpesh SHAH, Tokyo-to (JP); Nathan KAU, Tokyo-to (JP); Zoltan BECK, Tokyo-to (JP)

(73) Assignee: TOYOTA JIDOSHA KABUSHIKI KAISHA, Aichi-ken (JP)

(21) Appl. No.: 18/983,095

(22) Filed: Dec. 16, 2024

(30) Foreign Application Priority Data
Dec. 20, 2023 (JP) 2023-214818

(51) Int. Cl. G06T 7/73; G01S 17/894; G06V 10/26; G06V 10/762; G06V 10/82; G06V 40/10

(52) U.S. Cl. CPC G06T 7/73; G01S 17/894; G06V 10/26; G06V 10/762; G06V 10/82; G06V 40/10; G06T 2207/20081; G06T 2207/20084; G06T 2207/30196

(57) ABSTRACT

A system according to the present disclosure includes: a robot including a 2D range sensor configured to detect a distance to a nearby point; a camera configured to take an image of an area around the robot; a detection unit configured to detect a bounding box surrounding a person included in the image; a determination unit configured to determine, for each point included in the bounding box detected by the range sensor, whether or not the detected point corresponds to the person; and an estimation unit configured to estimate a 3D position of the person based on a distance to a detected point determined to correspond to the person.

### CROSS REFERENCE TO RELATED APPLICATIONS

This application is based upon and claims the benefit of priority from Japanese patent application No. 2023-214818, filed on Dec. 20, 2023, the disclosure of which is incorporated herein in its entirety by reference.

### BACKGROUND

The present disclosure relates to a system, a method, and a program for estimating a 3D (three-dimensional) position of a person.

Patent Literature 1 discloses a system including a camera and LiDAR (Light Detection and Ranging, Laser Imaging Detection and Ranging). An image segmentation mapper performs segmentation of an image. Each segmentation is associated with spatial coordinates. A depth mapper generates a depth map of a scene based on depth values and spatial coordinates.
Patent Literature 1: Published Japanese Translation of PCT International Publication for Patent Application, No. 2018-526641

### SUMMARY

In the above-described system, in general, three major problems occur when 2D (two-dimensional) LiDAR is used to the detection of the position of a human being using a mobile robot. Specifically, these problems are: signals of LiDAR are sparse; the amount of computation is limited; and it is necessary to manually annotate a large number of labels.

The present disclosure has been made in view of the above-described background, and the objective thereof is to provide a system, a method, and a program capable of accurately estimating the position of a person present near a robot.

A system according to an aspect of the present disclosure includes: a mobile robot including a 2D (two-dimensional) range sensor configured to detect a distance to a nearby point; a camera configured to take an image of an area around the mobile robot; a detection unit configured to detect a bounding box surrounding a person included in the image; a determination unit configured to determine, for each point included in the bounding box detected by the 2D range sensor, whether or not the detected point corresponds to the person; and an estimation unit configured to estimate a 3D (three-dimensional) position of the person based on a distance to a detected point determined to correspond to the person.

In the above-described system, the determination unit may be a transformer neural network configured to receive position data including an angle and a distance from the 2D range sensor and output binary data indicating whether or not each of the detected points corresponds to the person.

In the above-described system, the transformer neural network may be a machine learning model trained through self-supervised learning using knowledge distillation.

In the above-described system, learning data of the transformer neural network may be obtained by a segmentation network configured to segment the person shown in the image taken by the camera and a feature estimator combined with a clustering algorithm for extracting a detected point located at an ankle of the person.

A method according to an aspect of the present disclosure is a method for estimating a 3D position of a person using a computer, including: detecting a distance to a nearby point by using a 2D range sensor installed in a mobile robot; taking an image of an area around the mobile robot by a camera; detecting a bounding box surrounding a person included in the image; determining, for each point included in the bounding box detected by the 2D range sensor, whether or not the detected point corresponds to the person; and estimating a 3D position of the person based on a distance to a detected point determined to correspond to the person.

In the above-described method, the transformer neural network may determine whether or not the detected point corresponds to the person, and the transformer neural network may be a transformer neural network configured to receive position data including an angle and a distance from the 2D range sensor and output binary data indicating whether or not each of the detected points corresponds to the person.

In the above-described method, the transformer neural network may be a machine learning model trained through self-supervised learning using knowledge distillation.

In the above-described method, learning data of the transformer neural network may be data obtained by a segmentation network configured to segment the person shown in the image taken by the camera, and a feature estimator combined with a clustering algorithm for extracting a detected point located at an ankle of the person.

A program according to an aspect of the present disclosure causes a computer to perform the above-described method.

According to the present disclosure, it is possible to provide a system, a method, and a program capable of accurately estimating the position of a person present near a robot.

The above and other objects, features and advantages of the present disclosure will become more fully understood from both the detailed description given below as well as the accompanying drawings.

### BRIEF DESCRIPTION OF DRAWINGS

FIG. 1 is a schematic diagram showing an overall configuration of a system;

FIG. 2 is a block diagram showing a control system of the system;

FIG. 3 is a diagram schematically showing Image I of a camera 21;

FIG. 4 is a schematic diagram for explaining a determination process in a determination unit;

FIG. 5 is a block diagram showing a configuration of a processing apparatus for generating learning data; and

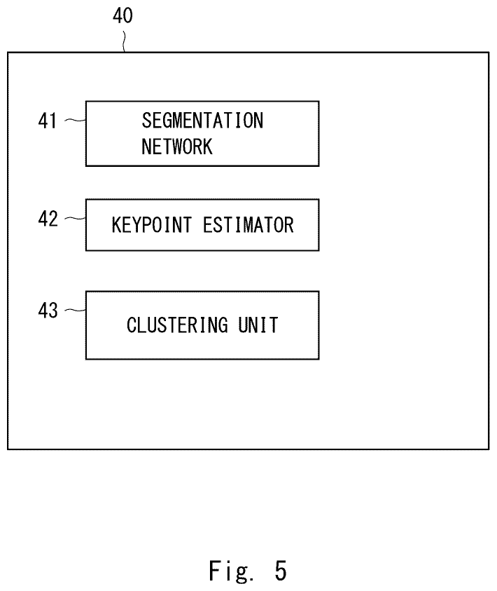

FIG. 6 is a diagram for explaining a result of segmentation and keypoint estimation.

### DESCRIPTION OF EMBODIMENTS

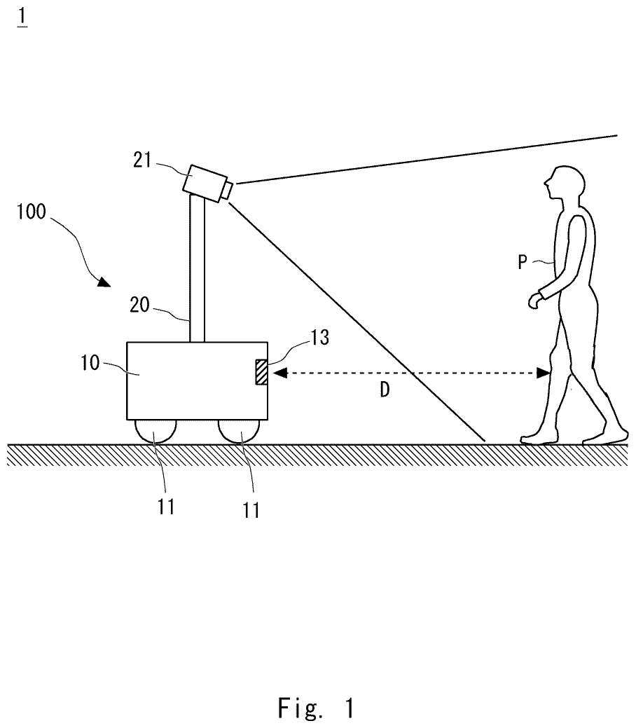

A configuration of a system and a method will be described with reference to FIG. 1. FIG. 1 is a schematic diagram showing the overall configuration of system 1 including a mobile robot 100 (also referred to simply as a robot 100). In this example, the robot 100 is an autonomous mobile robot including wheels 11. Therefore, the robot 100 can autonomously move along a route to a destination.

The robot 100 includes a body part 10, wheels 11, a range sensor 13, a support pillar 20, and a camera 21. The body part 10 serves as a chassis that holds the rotating wheels 11. The body part 10 also serves as a housing in which a battery, wheel motors, a control unit, and the like (not shown) are housed. The body part 10 may be a carriage that transports baggage or the like. The support pillar 20 for supporting the camera 21 is attached to the body part 10. That is, the camera 21 is mounted on the support pillar 20.

The camera 21 is a CMOS (Complementary Metal Oxide Semiconductor) image sensor, a CCD (Charge Coupled Device) image sensor, or the like. The camera 21 may be a built-in camera of a smartphone, a tablet-type computer, or the like. The camera 21 may be a color camera such as an RGB camera. The camera 21 takes an image (e.g., a still image of a moving image) of an area around the robot 100. For example, the camera 21 faces in the forward direction of the robot 100, so that it takes an image of a view ahead of the robot 100 in its moving direction. Therefore, when there is a person P ahead of the robot 100, the camera 21 takes an image including the person P (i.e., an image in which the person P is shown). The camera 21 outputs the image data to the control unit (which will be described later).

The range sensor 13 is disposed on a side of the body part 10. The range sensor 13 is, for example, an optical sensor, and measures a distance D to a person P present near the robot 100. The range sensor 13 is preferably a 2D (two-dimensional) range sensor such as 2D LiDAR (Light Detection And Ranging). A range sensor 13 may be provided on each of the four sides of the body part 10, i.e., each of the front, rear, left, and right sides thereof, or may be provided only on some of the sides of the body part 10. The range sensor 13 includes a light source and a photosensor. The range sensor 13 emits, for example, measurement light forward, i.e., in the moving direction. Then, the range sensor 13 detects reflected light reflected by the person P, a nearby object, or the like (hereinafter collectively referred to as nearby points).

For example, the range sensor 13 measures distances to nearby points as point group data. The range sensor 13 detects a distance to a nearby point in each direction by scanning measurement light. Examples of nearby points includes a wall, an obstacle, other robots, and a person. For example, the range sensor 13 scans laser light at certain angular intervals on an arbitrary plane such as a horizontal plane. The range sensor 13 detects a distance to a nearby point by changing the scanning angle, i.e., the detecting direction.

The range sensor 13 can acquire position data indicating a distance to a detected point. The position data is data in which a distance is associated with a detecting direction. That is, the position data of each detected point includes values of a detecting direction (scanning angle) and a distance. The range sensor 13 outputs the position data to the control unit (which will be described later). Note that the relationship between detecting directions of the range sensor 13 and angles of view of the camera 21 is known in advance. That is, since the position at which the range sensor 13 is disposed and that of the camera 21 are fixed in the robot 100, position data of the range sensor 13 can be converted into xy-coordinates in the image. That is, a detected point that is detected by the range sensor 13 and represented by 3D coordinates can be projected onto a 2D image taken by the camera 21.

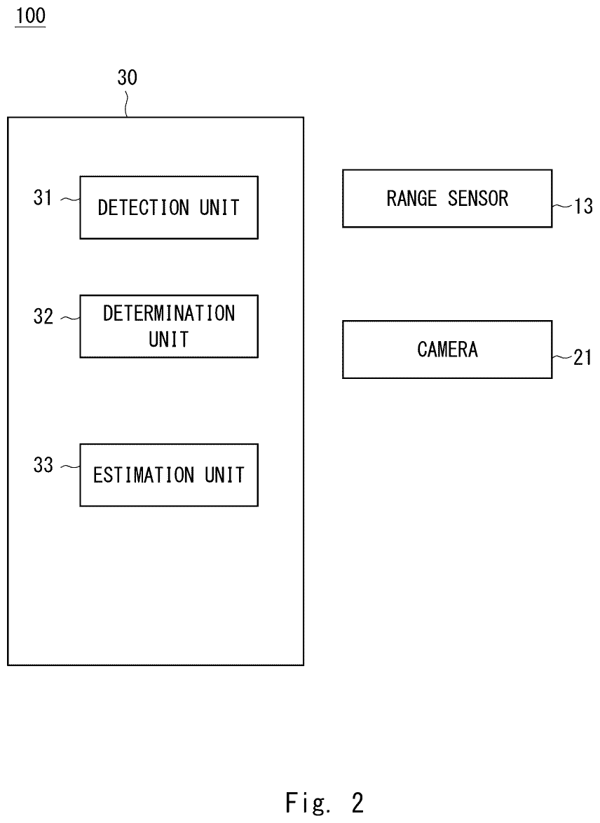

Next, a configuration of the control unit and processes performed thereby will be described. FIG. 2 is a block diagram showing a configuration of a processing apparatus 30. The processing apparatus 30 includes a detection unit 31, a determination unit 32, and an estimation unit 33.

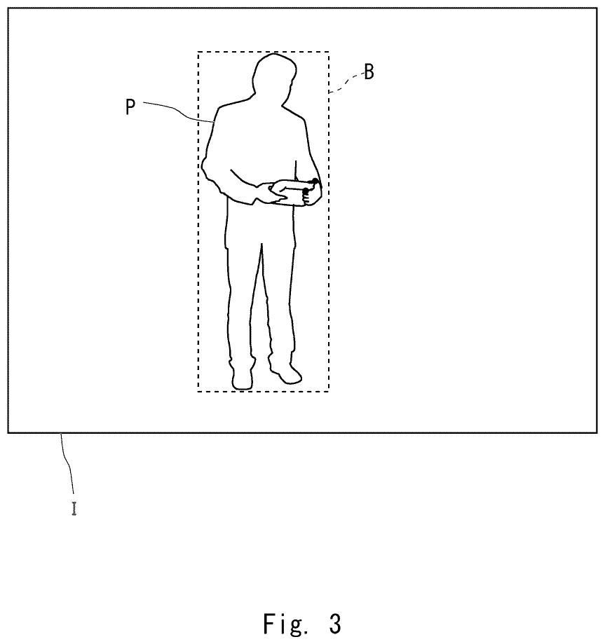

The detection unit 31 detects a bounding box (boundary box) surrounding a person included (i.e. shown) in an image (e.g., a still image of a moving image) taken by the camera 21. As shown in FIG. 3, a bounding box B is represented by a rectangular frame surrounding a person P in Image I.

The detection unit 31 detects the bounding box B surrounding the person P by running a bounding box detection network. A known method can be used for the bounding box detection. For example, the detection unit 31 detects a person P included in Image I by performing object detection through image processing. Then, the detection unit 31 specifies a rectangular frame surrounding the person P as a bounding box B in Image I. The bounding box B is represented by xy-coordinates or the like in Image I. The detection unit 31 may detect a bounding box B by using a machine learning model based on deep learning or the like.

It is possible to perform down sampling at a high speed by trimming Image I using the bounding box B. Since the bounding box detection is used only to adjust the network, it is not necessary to perform bounding box detection with high precision. Therefore, the process for detecting a bounding box can be performed at a high speed.

The determination unit 32 determines, for each of detected points that are detected by the range sensor 13 and included in the bounding box B, whether or not the detected point corresponds to (e.g., belongs to) the person P. For example, the determination unit 32 uses a transformer which receives, for each detected point, position data including a detecting direction and a distance from the range sensor 13 and outputs binary data indicating whether the detected point corresponds to (e.g., belongs to) the person or not. The transformer may be a transformer neural network generated by machine learning. The transformer neural network may be a machine learning model trained by self-supervised learning (SSL: Self-Supervised Learning) using knowledge distillation.

For example, the determination unit 32 generates binary data indicating a determination result. For example, when a detected point DP detected by the range sensor 13 corresponds to (e.g., belongs to) the person P, a data value is set to “1”, and whereas when the detected point does not correspond to the person P, the data value is set to “0”. Specifically, the determination unit 32 generates such binary data by binarizing each of the detected points included in the bounding box B.

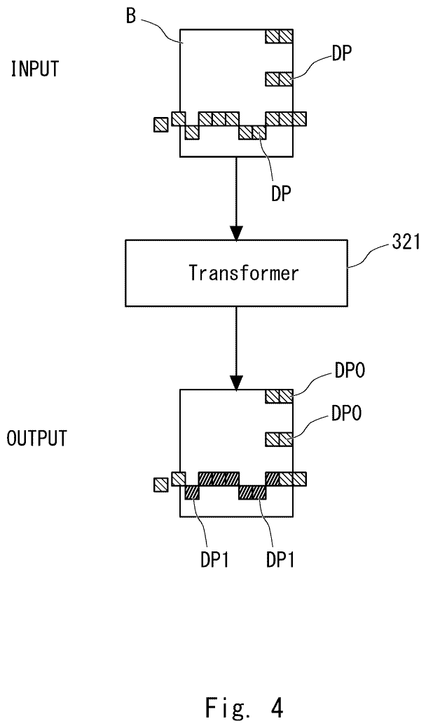

FIG. 4 is a schematic diagram for explaining a determination process performed by the determination unit 32. As shown in FIG. 4, position data of the detected point DP in the bounding box B is input to a transformer 321. As described above, the position data of the detected point DP includes a detecting direction and a distance in the range sensor 13.

Position data of each of N detected points (N is an integer of two or larger) is input to the transformer 321. Then, the transformer 321 generates binary data for each detected point DP. That is, the transformer 321 outputs a N-bit data string. In the output of the transformer 321 shown in FIG. 4, each of the detected points DP corresponding to the person P is represented as a detected point DP1, and each of the detected points DP that do not correspond to the person is represented as a detected point DP0. Since the output of the transformer 321 is used as binary classification, i.e., classification according to whether each detected point belongs (i.e., corresponds) to the person or not, it is a sequence having the same length as one that passes through a sigmoid layer.

The estimation unit 33 estimates the 3D position of the person P based on distances to detected points DP1 which have been determined to correspond to the person P. For example, the median of the distances of a plurality of detected points DP1 is calculated as the distance from the range sensor 13 to the person P. The estimation unit 33 calculates the 3D coordinates of the person P based on the distance to the person P. The estimation unit 33 specifies a direction to the person P based on the image or the position data. The estimation unit 33 estimates the 3D position based on the distance and the direction. For example, the estimation unit 33 can estimate the 3D coordinates of the person P based on the xy coordinates of the person P in Image I taken by the camera 21 or the direction in the position data.

As described above, the determination unit 32 determines, for each of the detected points DP, whether the detected point DP is a detected point DP1 corresponding to (e.g., belonging to) the person P or a detected point DP0 that does not correspond to the person P. As a result, it is possible to accurately make a determination with a limited amount of calculation. Further, the estimation unit 33 can accurately estimate a 3D position based on sparse signals transmitted from the 2D range sensor 13. The transformer 321 can be formed without manually attaching a large number of labels.

The transformer 321 is a transformer neural network that receives position data including a detecting direction and a distance from the range sensor 13 and outputs binary data indicating whether a detected point DP corresponds to a person or not. Specifically, the transformer 321 performs binomial classification as to whether each detected point belongs (i.e., corresponds) to a person or not. It is possible to accurately make a determination with a limited amount of computation.

The transformer 321 can be formed without manually attaching a large number of labels.

The transformer 321 may be a machine learning model trained through self-supervised learning using knowledge distillation. By using such a transformer 321, it is possible to accurately make a determination while reducing (or preventing the increase in) the calculation load. It is possible to enable a robot 100 including a 2D range sensor to estimate the 3D position of a human being. The processing apparatus 30 can accurately estimate the position of a human being even when there is a constraint on the calculation. Since the robot 100 can accurately estimate the position of a person, it can appropriately perform a task such as transportation. Further, it is possible to accurately estimate a position from sparse signals detected by the 2D range sensor 13.

Machine learning of the transformer 321 will be described hereinafter. Firstly, learning data used in the machine learning will be described. Data obtained by a segmentation network that segments a person shown in an image taken by a camera, and a keypoint estimator (feature estimator) combined with a clustering algorithm for extracting a detected point located at an ankle of the person is used as learning data. That is, data obtained by processing in the segmentation network, the keypoint estimator, and the clustering algorithm is used as learning data. Then, by performing machine learning using the learning data, various parameters and the like of the transformer 321 are optimized.

As shown below, a processing apparatus such as a server generates data for learning. FIG. 4 is a block diagram showing a configuration of a processing apparatus 40 that generates learning data (also called training data). The processing apparatus 40 includes a segmentation network 41, a keypoint estimator 42, and a clustering unit 43. The processing apparatus 40 stores therein algorithms for various processes such as segmentation, keypoint (feature point) estimation, and clustering. Each of these algorithms can be implemented by, for example, a machine learning model of a deep neural network. For example, CNN (Convolutional Neural Network) or FCN (Fully Convolutional Network) can be used. The processing apparatus 30 may also be used as the processing apparatus 40, or a separate apparatus may be used as the processing apparatus 40. The segmentation network 41, the keypoint estimator 42, and the clustering unit 43 may be existing models obtained by deep learning or the like.

The processing apparatus 40 extracts an image taken by the camera 21 and a data set of position data of detected points detected by the range sensor 13 from a log of the robot 100. Note that the robot equipped with various sensors for detecting data may be the same type of robot as the robot 100 shown in FIG. 1, or may be a different type of robot. That is, the robot for collecting learning data may be the same type of robot as the robot 100, which estimates 3D position of a person P, or may be a different type of robot. Further, the camera and the range sensor used for collecting data may be those of the same types as the camera 21 and the range sensor 13, respectively, used for position estimation, or may be those of different types. For example, the range sensor 13 may be 2D LiDAR or 3D LIDAR. Further, any of various types of RGB cameras may be used as the camera 21.

The segmentation network 41 is a machine learning model for segmenting Image I. For example, the segmentation network 41 classifies each pixel in Image I into a respective class (object). The segmentation network 41 predicts a class label for each of all objects included (i.e., shown) in Image I by instance segmentation. In this way, the segmentation network 41 can specify pixels in a class(es) corresponding to (e.g., belonging to) the person P in Image I.

The keypoint estimator 42 is a machine learning model for estimating keypoints (feature points) of the person P from Image I. The keypoint estimator 42 estimates keypoints of the person P by a keypoint estimation (feature point estimation) process. The keypoint estimator 42 estimates (i.e., infers) pixels of specific parts of the person P from among the pixels corresponding to the person P.

For example, the keypoint estimator 42 estimates positions of joints, such as elbows, shoulders, a pelvis, wrists, ankles, and knees, as keypoints by image processing. The keypoint estimator 42 estimates the xy-coordinates of the keypoints in Image I.

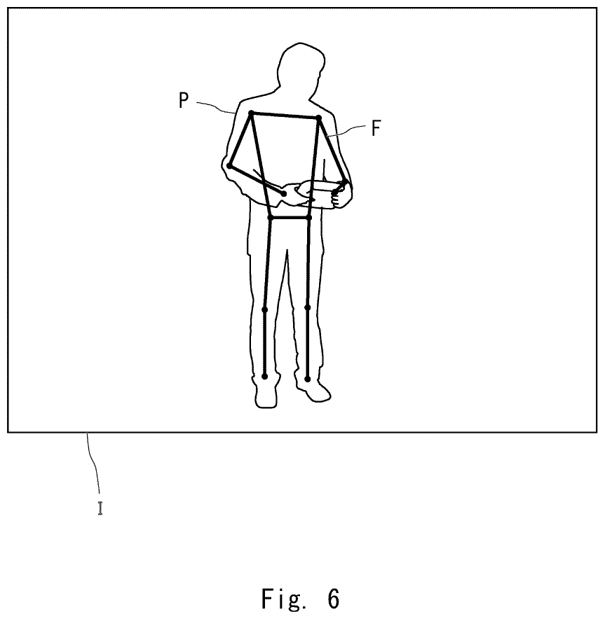

The processing apparatus 40 can estimate the posture and the skeletal structure of the person P from the estimation result of the keypoint estimator 42. FIG. 6 is a schematic diagram showing a skeletal structure F obtained from the feature points of the person P obtained by the keypoint estimation. For example, the processing apparatus 40 can estimate the skeletal structure F of the person P by connecting the positions of the joints with one another.

The clustering unit 43 is an algorithm for clustering (i.e., devising into clusters) detected points detected by the range sensor 13. For example, the clustering unit 43 clusters (i.e., devising into clusters) detected points detected by the range sensor 13 by using a DBSCAN (Density-Based Spatial Clustering of Applications with noise) clustering algorithm. In the DBSCAN clustering algorithm, clustering is performed according to the density of detected points. That is, the clustering unit 43 expands the area of a cluster until the density of detected points decreases to or below a certain value. A plurality of detected points included in an area in which the density of detected points is equal to or higher than a certain value belong to one cluster. The processing apparatus 40 performs clustering and thereby divides a plurality of detected points into a plurality of clusters.

The processing apparatus 40 extracts a cluster corresponding to an ankle from a plurality of clusters obtained by the clustering. The processing apparatus 40 specifies the cluster of the ankle by comparing the result of the keypoint estimation with the result of the clustering. Specifically, a cluster closest to the keypoint estimated as the ankle is specified as, among the plurality of clusters, a cluster corresponding to the ankle. Note that the range sensor 13 is preferably set so as to detect the height of an ankle and a direction thereto.

The processing apparatus 40 extracts position data of detected points included in the cluster corresponding to the ankle and data of the image as teacher data. The position data of detected points located at the position of the ankle becomes accurate information (correct labels, teacher labels). The processing apparatus 40 can automatically attach labels for the learning data. That is, detected points with labels are automatically generated. It is possible to prevent erroneous marking from being made due to mismatching between the range sensor 13 and the camera 21.

The processing apparatus 40 performs supervised learning by using the teacher data in which correct information is associated with image data. The processing apparatus 40 updates each parameter of the transformer 321. That is, the processing apparatus 40 tunes parameters so as to optimize the network of the transformer 321.

As described above, the processing apparatus 40 generates the transformer 321 by performing machine learning using learning data. The processing apparatus 40 can form the transformer 321 by supervised learning. It is possible to obtain the effect of knowledge distillation from high-precision segmentation and the keypoint estimator for a human being. The transformer 321 can be formed by self-supervised learning through knowledge distillation. The transformer 321 may be disposed in the robot 100 or may be implemented online.

As described above, efficient annotation and machine learning can be performed. Further, since the determination unit 32 make a determination based on position data of detected points, the determination unit 32 can appropriately make a determination even when a different sensor model is used or even in a different environment.

Since the processing for segmentation, keypoint estimation, and clustering in the processing apparatus 40 requires a large computational load, it is difficult to carry out such processing online. The processing apparatus 40 performs the above-described processing offline in order to generate detected points with correct labels (ground truth) as learning data. The processing apparatus 40 can generate learning data without manually attaching labels for a large amount of data. It is possible to determine whether a detected point located at an ankle belongs to a human being or not with high determination accuracy. Further, detected points of objects or the like other than the human being can also be used as learning data by attaching labels to them.

Note that the present invention is not limited to the above-described embodiments, and they can be modified as appropriate without departing from the scope and spirit of the invention. Further, in the present disclosure, some or all pf the processes performed in the processing apparatus 30 can be implemented by having a processor such as a CPU (Central Processing Unit) to execute a computer program for a unit or all of the processing in the processing apparatus 30. For example, each of the processing apparatuses 30 and 40 and the like can be implemented as an apparatus capable of executing a program such as a central processing unit of a computer. Further, various functions can also be implemented by a program(s).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A system comprising:
a mobile robot including a 2D (two-dimensional) range sensor configured to detect a distance to a nearby point;
a camera configured to take an image of an area around the mobile robot;
a detection unit configured to detect a bounding box surrounding a person included in the image;
a determination unit configured to determine, for each point included in the bounding box detected by the 2D range sensor, whether or not the detected point corresponds to the person; and
an estimation unit configured to estimate a 3D (three-dimensional) position of the person based on a distance to a detected point determined to correspond to the person.

2. The system according to claim 1, wherein the determination unit is a transformer neural network configured to receive position data including a detecting direction and a distance from the 2D range sensor and output binary data indicating whether or not each of the detected points corresponds to the person.

3. The system according to claim 2, wherein the transformer neural network is a machine learning model trained through self-supervised learning using knowledge distillation.

4. The system according to claim 3, wherein learning data of the transformer neural network is data obtained by a segmentation network configured to segment the person shown in the image taken by the camera and a keypoint estimator combined with a clustering algorithm for extracting a detected point located at an ankle of the person.

5. A method for estimating a 3D position of a person using a computer, comprising:
detecting a distance to a nearby point by using a 2D range sensor installed in a mobile robot;
taking an image of an area around the mobile robot by a camera;
detecting a bounding box surrounding a person included in the image;
determining, for each point included in the bounding box detected by the 2D range sensor, whether or not the detected point corresponds to the person; and
estimating a 3D position of the person based on a distance to a detected point determined to correspond to the person.

6. The method according to claim 5, wherein the transformer neural network determines whether or not the detected point corresponds to the person, and the transformer neural network is a transformer neural network configured to receive position data including an angle and a distance from the 2D range sensor and output binary data indicating whether or not each of the detected points corresponds to the person.

7. The method according to claim 6, wherein the transformer neural network is a machine learning model trained through self-supervised learning using knowledge distillation.

8. The method according to claim 6, wherein learning data of the transformer neural network is data obtained by a segmentation network configured to segment the person shown in the image taken by the camera, and a feature estimator combined with a clustering algorithm for extracting a detected point located at an ankle of the person.

9. A non-transitory computer readable medium storing a program for causing a computer to perform a method according to claim 5.
